(19) United States
(12) Patent Application Publication
(10) Pub. No.: US 2014/0185856 A1
(43) Pub. Date: Jul. 3, 2014

(54) LANYARDS FOR PORTABLE ELECTRONIC DEVICES

(71) Applicant: KOSS CORPORATION, Milwaukee, WI (US)

(72) Inventors: Michael J. Koss, JR., Milwaukee, WI (US); Kegan McDaniel, Wadsworth, IL (US)

(73) Assignee: KOSS CORPORATION, Milwaukee, WI (US)

(21) Appl. No.: 13/733,389

(22) Filed: Jan. 3, 2013

(51) Int. Cl. H04R 1/10; H01R 3/00

(52) U.S. Cl. CPC H04R 1/1033; H01R 3/00
USPC 381/384; 174/74 R

(57) ABSTRACT

A lanyard assembly for securing a portable electronic device relative to a user. The lanyard assembly can include an I/O device, an electrical conductor, and a multi-ended portion. A cord can extend from the multi-ended portion to the I/O device and can form a loop that can be positioned around a user's neck. The electrical conductor can extend through the cord. The multi-ended portion can include a first elongate portion and a second elongate portion. An electrical connector can extend from the first elongate portion and can be configured to electrically connect to a portable electronic device. A physical connector, such as a clip, can extend from the second elongate portion and can be configured to receive at least a portion of the portable electronic device.

### BACKGROUND

Portable electronic devices, such as media players, cellular phones, and PDAs, have become increasingly smaller, lighter, and more powerful. They are frequently carried around by people who are moving from place to place and/or performing physical activities, such as walking, running, cycling, and stair climbing, for example. As the user moves, the portable electronic device can be held in the user's hand, worn by the user, or otherwise secured relative to the user's body. To free the user's hands, the user may prefer to secure the portable electronic device relative to his/her body. Due to the various types and configurations of portable electronic devices, it is difficult to design a device for securing various portable electronic devices relative to the various users. Furthermore, it is difficult to design a device for securing various portable electronic devices that holds the device securely, yet can easily and quickly be removed therefrom.

### SUMMARY

In one general aspect, the present invention is directed to a lanyard assembly that comprises: (i) an I/O device (e.g., an earphone); (ii) an electrical conductor; (iii) a multi-ended portion; and (iv) a cord. The multi-ended portion may comprise first and second elongate portions. The first elongate portion may comprise an electrical connector, wherein the electrical conductor extends between the electrical connector and the I/O device, and wherein the electrical connector is configured to electrically connect to a portable electronic device. The second elongate portion may comprise a physical connector that is configured to receive a portion of the portable electronic device. In addition, the cord may extend from the multi-ended portion to the I/O device, and comprise at least a portion of the electrical conductor. Also, the cord may be configured to form a loop for placement around a person's neck. In various embodiments, the lanyard assembly may comprise two I/O devices, e.g., earphones. In such an embodiment, the user can insert the earphones into his or her ears, have the lanyard draped around the his or her neck, hold the user's portable electronic device through the physical connector, while at the same time having an electrical connection between the I/O devices and the portable electronic device, such that, for example, the user receives audio or other content from the portable electronic device via the I/O device(s).

According to various implementations and embodiments, the physical connector may comprise a clip, and the clip and the portion of the portable electronic device may form a snap-fit connection. The clip may also comprise an aperture configured to receive the portion of the portable electronic device, wherein the aperture defines an unsecured portion and a secured portion, and wherein a projection projects into the aperture between the unsecured portion and the secured portion. Also, the portion of the portable electronic device may comprise a protrusion, and the clip may be configured to receive the protrusion to physically connect the second elongate portion to the portable electronic device. Additionally, the portable electronic device may comprise a case that at least partially surrounds the portable electronic device, and wherein the protrusion protrudes from the case. The electrical connector may comprise an audio jack, and the personal electronic device may comprise an outlet configured to receive the audio jack. Further, the first elongate portion may comprise a flexible first length, the second elongate portion may comprise a flexible second length, where the flexible second length is less than the flexible first length. In addition, the electrical conductor may be a first electrical conductor, and the lanyard assembly may further comprise: (i) a second I/O device; and (ii) a second electrical conductor, wherein the second electrical conductor extends between the second I/O device and at least one of the electrical connector and the first electrical conductor. Still further, the first and second electrical conductors may extend through a node, wherein the first electrical conductor extends through the node in a first direction, wherein the second electrical conductor extends through the node in a second direction that is opposite to the first direction. Also, at least one of the first and second electrical conductors may be slidably held in the node.

These and other benefits and features of the present invention will be apparent from the description to follow.

### BRIEF DESCRIPTION OF THE FIGURES

Various embodiments of the present disclosure are described herein by way of example in conjunction with the following Figures, wherein:

FIG. 1 is a perspective view of a lanyard assembly according to various embodiments of the present disclosure;

FIG. 2 is a perspective view of the lanyard assembly of FIG. 1 with various elements removed therefrom and with a cord of the lanyard assembly shown in transparency to show the electrical conductors therein according to various embodiments of the present disclosure;

FIG. 3 is perspective view of a multi-ended portion of the lanyard assembly of FIG. 1 according to various embodiments of the present disclosure;

FIG. 4 is an elevational view of the physical connector of the multi-ended portion of FIG. 3 according to various embodiments of the present disclosure;

FIG. 5 is an elevational view of another physical connector of the multi-ended portion of FIG. 3 according to various embodiments of the present disclosure;

FIG. 6 is a perspective view of the multi-ended portion of FIG. 3 with a portable electronic device connected thereto according to various embodiments of the present disclosure;

FIG. 7 is an elevational view of the multi-ended portion and the portable electronic device of FIG. 6 according to various embodiments of the present disclosure;

FIG. 8 is another elevational view of the multi-ended portion and the portable electronic device of FIG. 6 according to various embodiments of the present disclosure;

FIG. 9 is a perspective view of a case for the portable electronic device of FIG. 6 according to various embodiments of the present disclosure;

FIG. 10 is an elevational view of the case of FIG. 9 according to various embodiments of the present disclosure;

FIG. 11 is schematic illustrating the lanyard assembly of FIG. 1 with the portable electronic device of FIG. 6 connected thereto and the lanyard assembly positioned relative to a user's neck according to various embodiments of the present disclosure; and

FIG. 12 is a perspective view of another multi-ended portion with the portable electronic device of FIG. 6 connected thereto according to various embodiments of the present disclosure.

### DETAILED DESCRIPTION

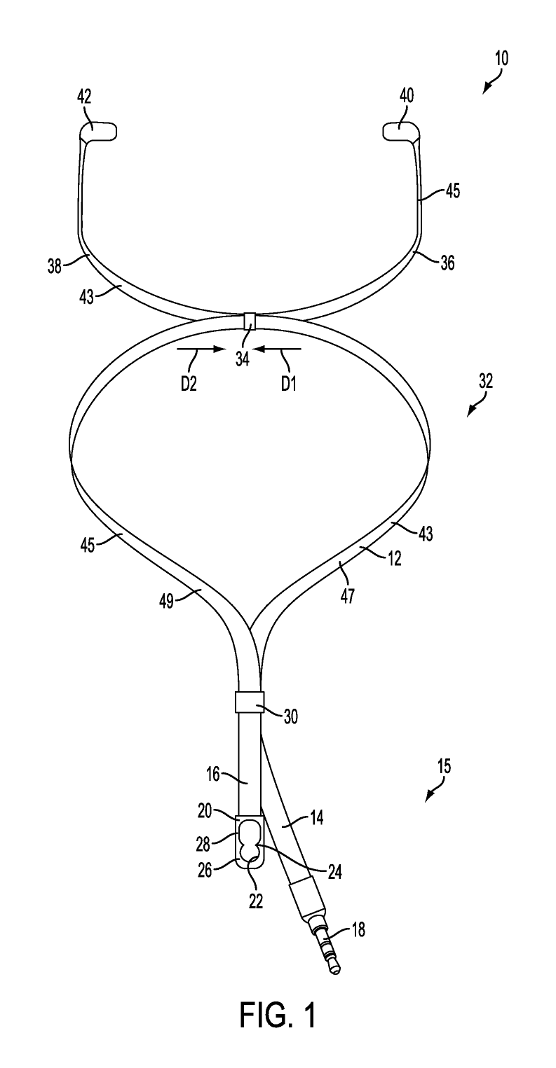

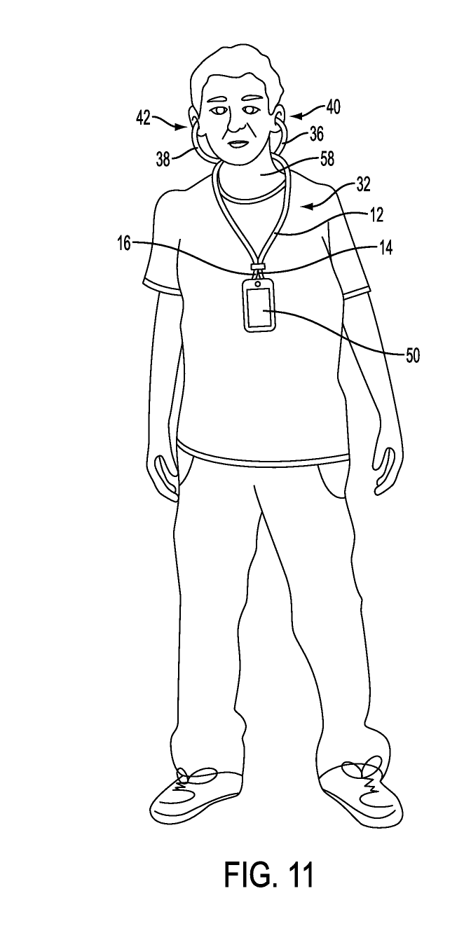

According to various embodiments, the present disclosure is directed to a lanyard assembly for holding a portable electronic device. Referring to FIGS. 1 and 11, a lanyard assembly 10 can have a cord 12 that is configured to form a loop 32. In various embodiments, the loop 32 can be placed around a user's neck 58 (FIG. 11), such that a portable electronic device 50 (FIG. 11) connected to the lanyard assembly 10 can hang from the lanyard assembly 10. Referring primarily to FIG. 1, the cord 12 can include a first cord portion 43 and a second cord portion 45. The first and second cord portions 43, 45 can extend from a base 30 of the cord 12, through a node, fastening, or slide adjuster 34, and to a peripheral I/O device 40, 42. The peripheral I/O device 40, 42 can be an earpiece, earphone, or personal speaker, for example. An end portion 36 of the second cord portion 45 can extend from the node 34 to the first earpiece 40, for example, and an end portion 38 of the first cord portion 43 can extend from the node 34 to the second earpiece 42, for example. Referring still to FIG. 1, the first cord portion 43 can extend through the node 34 in a first direction D1, and the second cord portion 45 can extend through the node 34 in a second direction D2. The second direction D2 can be opposite or substantially opposite to the first direction D1 such that the first and second cord portions 43, 45 of the cord 12 form the loop 32 between the base 30 and the node 34 of the cord 12.

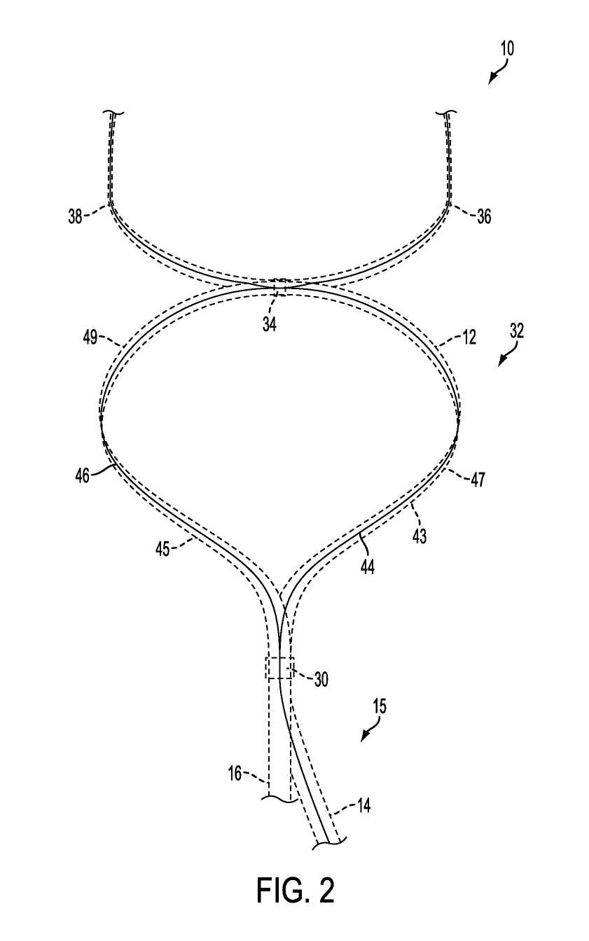

Referring primarily to FIGS. 1 and 2, the lanyard assembly 10 can be adjustable. For example, at least one of the first and second cord portions 43, 45 can be slidably received and/or held within the node 34 such that the size of the loop 32 and the length of an end portion 36, 38 extending from the node 34 are adjustable. As an end portion 36, 38 is shortened, the loop 32 can become larger, and as an end portion 36, 38 is lengthened, the loop 32 can become smaller. A user may enlarge the loop 32 to easily position the loop 32 over the user's head and around the user's neck 58 (FIG. 11), for example. Thereafter, the user may reduce the size of the loop 32 and extend the length of the end portions 36, 38 to ensure that the I/O devices 40, 42 comfortably and easily reach the user's ears, for example. In various embodiments, the lanyard assembly 10 can include additional nodes, and, in some of these embodiments, a node can be fixed to at least one of the first and second cord portions 43, 45. Multiple nodes can be placed at various locations along the cord 12 to prevent or minimize entanglement of the cord 12, for example.

In various embodiments, the cord 12 can be configured to carry one or more electrical signals. Referring to FIG. 2, the cord 12 can have an electrical conductor 44 and a sheath 47 positioned around the electrical conductor 44. In various embodiments, the electrical conductor 44 in the cord 12 can carry one or more electrical signals between an electrical connector 18 (FIG. 1) and a peripheral I/O device 42 (FIG. 1) that is operatively coupled to the cord 12. The electrical connector 18 can be positioned at a first distal end of the electrical conductor 44, for example, and the peripheral I/O device 42 can be positioned at a second distal end of the electrical conductor 44, for example. As described herein, the electrical connector 18 can be configured to operably mate with the portable electronic device 50 (FIG. 11). For example, the electrical connector 18 can be an audio jack, which can be positioned and/or retained in an audio outlet of the portable electronic device 50.

The cord 12 can include multiple conductors 44, 46 (FIG. 2) and multiple I/O devices 40, 42 (FIG. 1). For example, referring again to FIG. 2, the first cord portion 43 can comprise the first electrical conductor 44 and the first outer sheath 47. Furthermore, the second cord portion 45 can comprise a second electrical conductor 46 and a second outer sheath 49. In various embodiments, the first electrical conductor 44 can extend between the second I/O device 42 (FIG. 1) and the electrical connector 18 (FIG. 1), and the second electrical conductor 46 can extend between the first I/O device 40 (FIG. 1) and the electrical connector 18 or between the first I/O device 40 (FIG. 1) and the first electrical conductor 44. In various embodiments, a separate conductor extension can extend from the electrical connector 18 to the base 30 of the cord 12, and the first and/or second conductors 44, 46 can extend from the electrical connector 18.

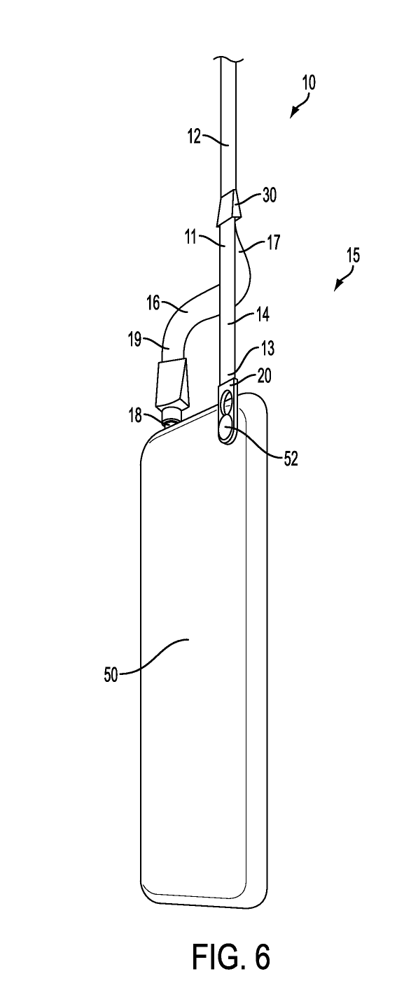

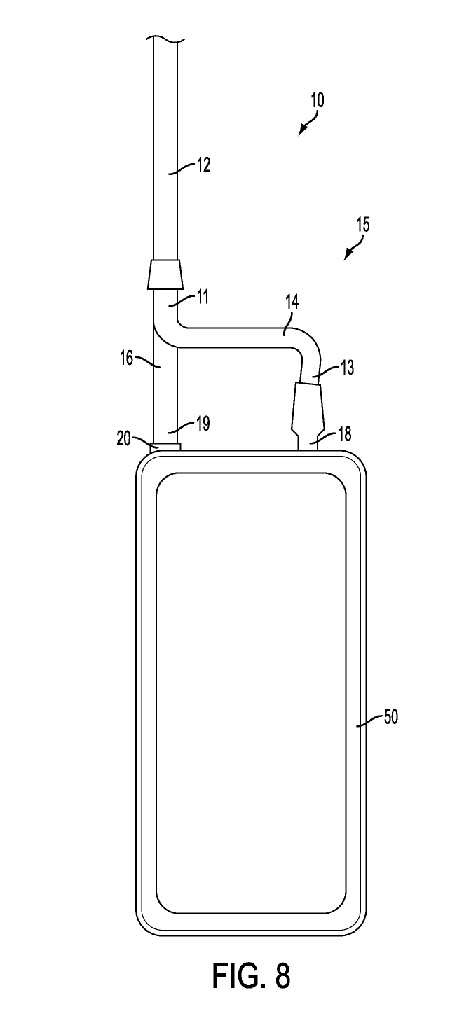

Referring primarily to FIGS. 6-8, the lanyard assembly 10 can include a multi-ended or multi-pronged (e.g., bifurcated) portion 15 extending from the base 30 of the cord 12. In various embodiments, the multi-ended portion 15 can include multiple prongs, portions or extensions. For example, the multi-ended portion 15 can include a first elongate portion 14 and a second elongate portion 16. The first elongate portion 14 can have a first end 11 and a second or distal end 13. In some embodiments, the first elongate portion 14 can have a flexible first length between the first end 11 and the second end 13. The first end 11 can extend from the base 30, and the electrical connector 18 can extend from the second end 13 of the first elongate portion 14. In various embodiments, the first elongate portion 14 can be configured to carry one of more signals between the electrical connector 18 and the first end 11 of the first elongate portion 14 and/or the base 30 of the cord 12. For example, the first electrical conductor 44 (FIG. 2) can extend through the first elongate portion 14 to carry one or more signals therethrough.

Referring still to FIGS. 6-8, the second elongate portion 16 can have a first end 17 and a second or distal end 19. In some embodiments, the second elongate portion 16 can have a flexible second length between the first end 17 and the second end 19. In various embodiments, the flexible second length of the second elongate portion 16 can be less than the flexible first length of the first elongate portion 14. When the portable electronic device 50 is connected to the lanyard assembly 10, there can be slack in the first elongate portion 14, which can prevent the electrical connector 18 from being pulled out of the audio jack of the portable electronic device 50 (FIGS. 6-8) when the portable electronic device 50 is secured relative to the user. In various embodiments, the first end 17 can extend from the base 30, and a physical connector 20 can extend from the second end 19 of the second elongate portion 16. In various embodiments, the first end 11 of the first elongate portion 14 can be secured to the first end 17 of the second elongate portion 16. In various embodiments, the physical connector 20 can be configured to receive at least a portion of the portable electronic device 50.

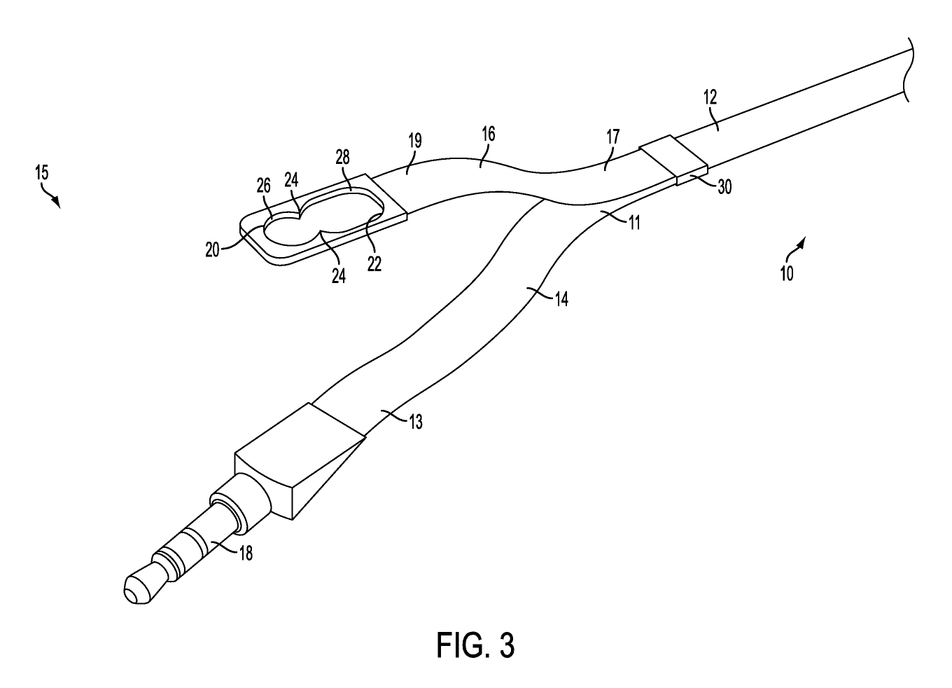

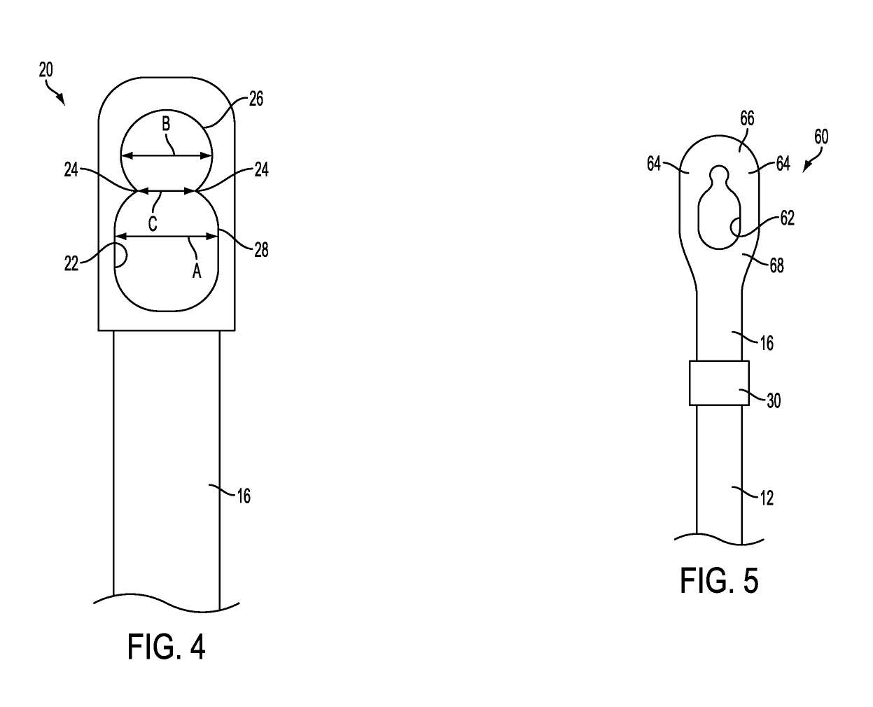

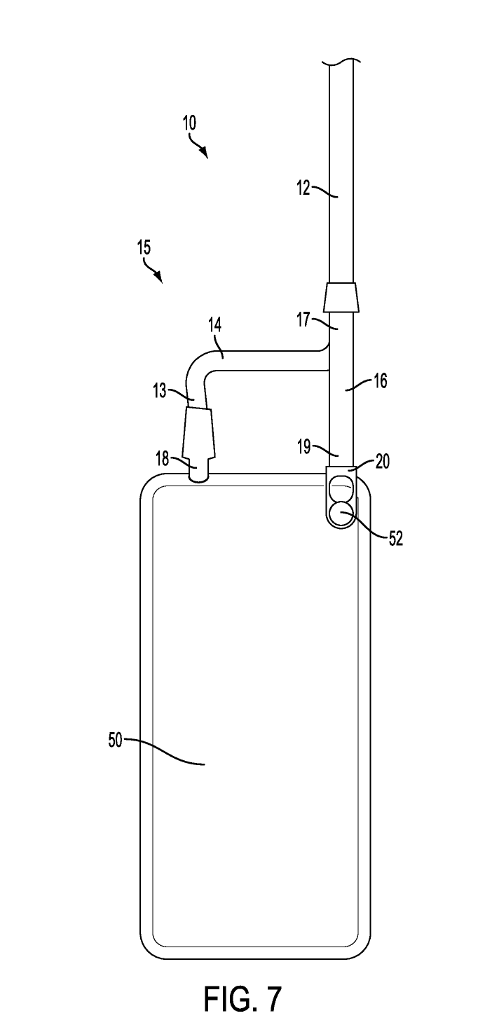

In various embodiments, the physical connector 20 can be a clip, fastener, clasp, hook, and/or catch, for example. Referring primarily to FIGS. 3 and 4, the physical connector 20 can be clip having an aperture 22 therethrough. In various embodiments, the aperture 22 can be configured to receive at least a portion of the portable electronic device 50 (FIGS. 6-8), and the aperture 22 can be defined to form a snap-fit connection with a portion of the portable electronic device 50, for example. In various embodiments, the aperture 22 can define an unsecured portion 28 and a secured portion 26. A projection 24 can project into the aperture 22 between the unsecured portion 28 and the secured portion 26, for example. In various embodiments, a portion of the portable electronic device 50 can slide within the unsecured portion 28 of the aperture 22 and can snap-fit past the projection 24 into the secured portion 26. Referring now to FIGS. 6 and 7 a protrusion or button 52 on the portable electronic device 50 can be received and/or snap-fit into the physical connector 20 to physically connect the second elongate portion 16 of the multi-ended portion 15 to the portable electronic device 50. In various embodiments, the button 52 can be spring-loaded and/or otherwise retractable into the body of the portable electronic device 50. As described herein, the button 52 can protrude from the portable electronic device 50 and/or from an attachment or accessory connected to the portable electronic device 50. Referring again to FIG. 4, the unsecured portion 28 can define a diameter A, the secured portion 26 can define a diameter B, and the projection 24 can define a diameter C. For example, diameter A can be greater than diameter B, and diameter B can be greater than diameter C, for example. The diameters A, B, and C can be selected such that the button 52 of the portable electronic device 50 moves easily within the unsecured portion (diameter A), is securely retained in the secured portion (diameter B), and snap-fits past the projections 24 (diameter C) of the aperture 22.

Referring primarily to FIG. 5, the lanyard assembly 10 can include a physical connector 60 having an aperture 62. The physical connector 60 can be similar to the physical connector 20 (FIGS. 3 and 4). In various embodiments, the aperture 62 can be configured to receive at least a portion of the portable electronic device 50 (FIGS. 6-8), and can define an unsecured portion 68 and a secured portion 66. A projection 64 can project into the aperture 62 between the unsecured portion 68 and the secured portion 66, for example. The design and dimensions of the physical connector 60 can differ from those of the physical connector 20, for example. In various embodiments, alternative physical connectors can extend from the second elongate portion 16. For example, a physical connector can be selected such that it forms a snap-fit connection or engagement with a portion of a selected portable electronic device. In some embodiments, a physical connector can be fixed to the second elongate portion 16. In other embodiments, a physical connector can be interchangeably secured to the second elongate portion 16 and/or the base 30 of the lanyard assembly 10, for example.

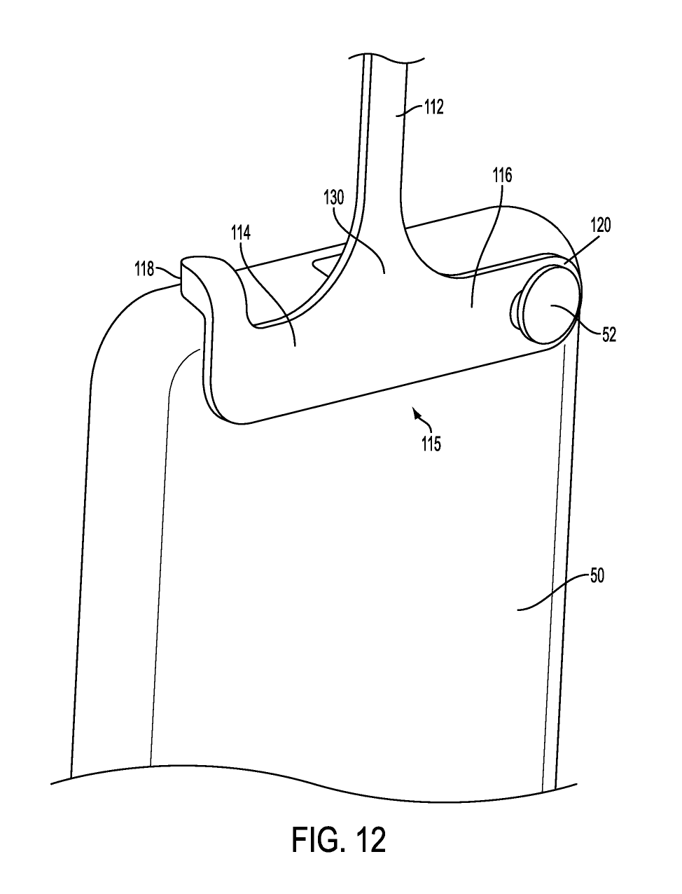

Referring now to FIG. 12, a lanyard assembly can include a multi-ended portion 115 extending from a base 130 of a cord 112. Similar reference characters indicate similar or corresponding parts. For example, the multi-ended portion 115 is similar to the multi-ended portion 15 (FIGS. 6-8), and the cord 112 is similar to the cord 12 (FIG. 1). In various embodiments, the multi-ended portion 115 can include a first elongate portion 114 and a second elongate portion 116. The first and second elongate portions 114, 116 can extend from the base 130 of the cord 112, and can extend in substantially opposite directions, for example. Further, an electrical connector 118 can extend from an end of the first elongate portion 114. In various embodiments, the first elongate portion 114 can be configured to carry one of more signals between the electrical connector 118 and the base 130 of the cord 112. For example, a first electrical conductor (not shown) can extend through the first elongate portion 114 to carry one or more signals therethrough. Furthermore, a physical connector 120 can extend from an end of the second elongate portion 116. Similar to the physical connector 20 (FIGS. 6-8) and the physical connector 60 (FIG. 5), the physical connector 120 can be configured to receive at least a portion of the portable electronic device 50. Further, the physical connector 120 can be a clip, fastener, clasp, hook, and/or catch, for example, and can form a snap-fit connection with a portion of the portable electronic device 50.

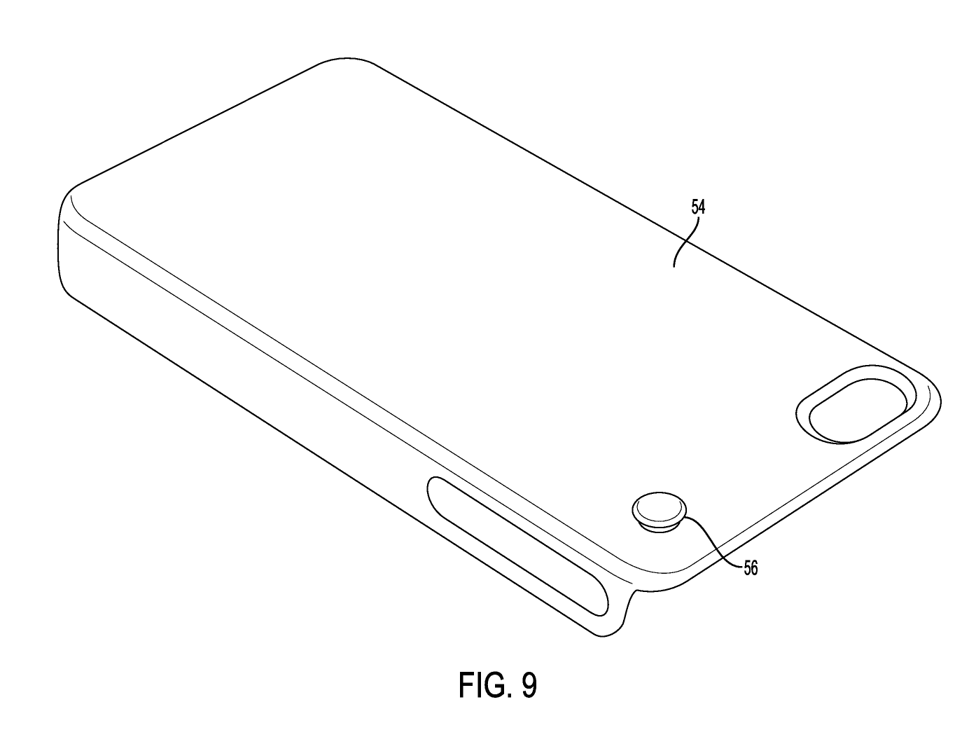

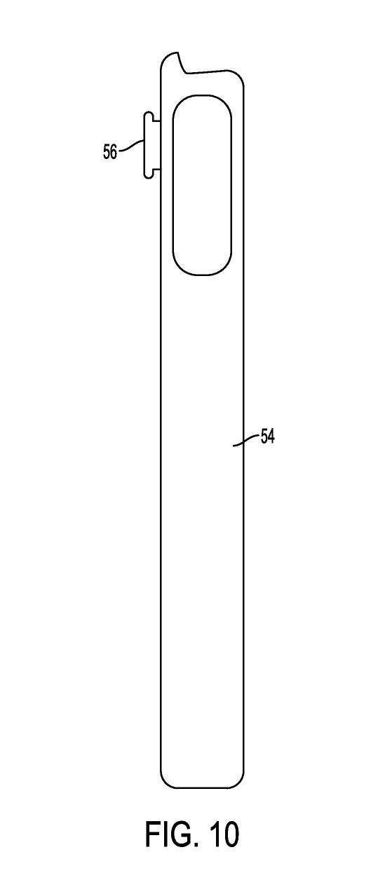

Referring now to FIGS. 9 and 10, a portable electronic device 50 can include an accessory, such as a case 54, that can be removably positioned around the portable electronic device 50. The case 54 can provide a decorative and/or personalized feature to the portable electronic device 50, and can protect the portable electronic device 50 from becoming scratched, water-damaged, or otherwise broken. In various embodiments, the case 54 can include a protrusion 56, which can be similar to protrusion or button 52 (FIGS. 6 and 7). The protrusion 56 can be received by the physical connector 20, for example, to connect the portable electronic device 50 to the lanyard assembly 10, for example. In various embodiments, the protrusion 56 and the physical connector 20 can form a snap-fit connection.

At least one embodiment of the present disclosure relates to a lanyard assembly comprising an I/O device, an electrical conductor, a multi-ended portion, and a cord. The multi-ended portioned comprises a first elongate portion and a second elongate portion. The first elongate portion comprises an electrical connector, wherein the electrical conductor extends between the electrical connector and the I/O device, and wherein the electrical connector is configured to electrically connect to a portable electronic device. The second elongate portion comprises a physical connector, wherein the physical connector is configured to receive a portion of the portable electronic device. The cord extends from the multi-ended portion to the I/O device, and the cord comprises at least a portion of the electrical conductor. Further, the cord is configured to form a loop for placement around a person's neck.

In some of these embodiments, the physical connector comprises a clip. In such embodiments, the clip and the portion of the portable electronic device form a snap-fit connection. In some of these embodiments, the clip comprises an aperture configured to receive the portion of the portable electronic device, and the aperture defines an unsecured portion and a secured portion, wherein a projection projects into the aperture between the unsecured portion and the secured portion. In some embodiments, the portion of the portable electronic device comprises a protrusion, and the clip is configured to receive the protrusion to physically connect the second elongate portion to the portable electronic device. In some of these embodiments, the portable electronic device comprises a case that at least partially surrounds the portable electronic device, and the protrusion protrudes from the case.

In some embodiments, the electrical connector comprises an audio jack, and the personal electronic device comprises an outlet configured to receive the audio jack. In some embodiments, the first elongate portion comprises a flexible first length and the second elongate portion comprises a flexible second length. In such embodiments, the flexible second length is less than the flexible first length. Further, in some embodiments, the electrical conductor is a first electrical conductor, and the lanyard assembly further comprises a second I/O device and a second electrical conductor. The second electrical conductor extends between the second I/O device and at least one of the electrical connector and the first electrical conductor. In some of these embodiments, the lanyard assembly comprises a node. In such embodiments, the first and second electrical conductors extend through the node such that the first electrical conductor extends through the node in a first direction, and the second electrical conductor extends through the node in a second direction that is opposite to the first direction. In some of these embodiments, at least one of the first and second electrical conductors is slidably held in the node.

In some embodiments, the lanyard assembly comprises a first cord portion and a second cord portion. The first cord portion comprises the first electrical conductor and a first outer sheath surrounding the first electrical conductor. The second cord portion comprises the second electrical conductor and a second outer sheath surrounding the second electrical conductor. In such embodiments, the first and second cord portions form a loop for placement around a user's neck.

At least one embodiment of the present disclosure relates to a device for holding a portable electronic such that the portable electronic hangs from the device. The device comprises a cord configured to form a loop for placement around a person's neck, and a multi-ended portion extending from the cord. The cord comprises an electrical conductor and a sheath around the electrical conductor. The multi-ended portion comprises a first elongate portion and a second elongate portion. The first elongate portion comprises a first end, a second end, and an electrical connector at the second end. The electrical connector is configured to operably mate with the portable electronic, and the first elongate portion is configured to carry one of more signals between the portable electronic and the first end. Further, the second elongate portion comprises a first end secured to the first end of the first elongate portion, a second end, and a physical connector at the second end. The physical connector is configured to snap-fit around a portion of the portable electronic.

In some of these embodiments, the first and second elongate portions are flexible. In some embodiments, the physical connector comprises a clip that comprises an aperture, wherein the portion of the portable electronic comprises a retractable button, and wherein the aperture of the clip is configured to receive the button to physically connect the second elongate portion to the portable electronic. In some embodiments, the device further comprises a pair of earphones.

At least one embodiment of the present disclosure relates to a device comprising a multi-ended device holder and a cord extending from the multi-ended device holder. The multi-ended device holder comprises a first flexible portion comprising an electrical connector at a distal end thereof, wherein the electrical connector is configured to operatively mate with a portable electronic device. The multi-ended device holder further comprises a second flexible portion comprising a clip at a distal end thereof, wherein the clip comprises an aperture configured to receive a portion of the portable electronic device. The cord is configured to form a loop for placement around a user's neck, and is configured to carry one or more signals between the multi-ended device holder and a peripheral I/O device operatively coupled to the cord.

In some of these embodiments, the portable electronic device comprises a protrusion, and the aperture of the clip is configured to snap-fit around the protrusion to physically connect the second flexible portion to the portable electronic device. In some embodiments, the electrical connector comprises an audio jack. In some embodiments, the cord comprises a pair of cord pieces and the peripheral I/O device comprises a pair of personal speakers. In such embodiments, each cord piece of the pair of cord pieces carries one of more signals to a personal speaker of the pair of personal speakers. In some of these embodiments, the device comprises a slide adjuster, wherein the pair of cord pieces each slidably extends through the slide adjuster, and wherein the cord pieces extend through the slide adjuster in opposite directions.

Various embodiments of the present invention are described and illustrated in this specification to provide an overall understanding of the steps and uses of the disclosed devices and methods. It is understood that the various embodiments described and illustrated in this specification are non-limiting and non-exhaustive. Thus, the invention is not limited by the description of the various non-limiting and non-exhaustive embodiments disclosed in this specification. In appropriate circumstances, the features and characteristics described in connection with various embodiments may be combined with the features and characteristics of other embodiments. Such modifications and variations are intended to be included within the scope of this specification. As such, the claims may be amended to recite any steps, limitations, features, and/or characteristics expressly or inherently described in, or otherwise expressly or inherently supported by, this specification. Further, Applicant(s) reserves the right to amend the claims to affirmatively disclaim steps, limitations, features, and/or characteristics that are present in the prior art regardless of whether such features are explicitly described herein. Therefore, any such amendments comply with the requirements of 35 U.S.C. §112, first paragraph, and 35 U.S.C. §132(a). The various embodiments disclosed and described in this specification can comprise, consist of, or consist essentially of the steps, limitations, features, and/or characteristics as variously described herein.

The grammatical articles “one”, “a”, “an”, and “the”, if and as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

1. A lanyard assembly, comprising:
an I/O device;
an electrical conductor;
a multi-ended portion, comprising:
a first elongate portion comprising an electrical connector, wherein the electrical conductor extends between the electrical connector and the I/O device, and wherein the electrical connector is configured to electrically connect to a portable electronic device; and
a second elongate portion comprising a physical connector, wherein the physical connector is configured to receive a portion of the portable electronic device; and
a cord extending from the multi-ended portion to the I/O device, wherein the cord comprises at least a portion of the electrical conductor, and wherein the cord is configured to form a loop for placement around a person's neck.

2. The lanyard assembly of claim 1, wherein the physical connector comprises a clip, and wherein the clip and the portion of the portable electronic device form a snap-fit connection.

3. The lanyard assembly of claim 2, wherein the clip comprises an aperture configured to receive the portion of the portable electronic device, wherein the aperture defines an unsecured portion and a secured portion, and wherein a projection projects into the aperture between the unsecured portion and the secured portion.

4. The lanyard assembly of claim 2, wherein the portion of the portable electronic device comprises a protrusion, and wherein the clip is configured to receive the protrusion to physically connect the second elongate portion to the portable electronic device.

5. The lanyard assembly of claim 4, wherein the portable electronic device comprises a case that at least partially surrounds the portable electronic device, and wherein the protrusion protrudes from the case.

6. The lanyard assembly of claim 1, wherein the electrical connector comprises an audio jack, and wherein the personal electronic device comprises an outlet configured to receive the audio jack.

7. The lanyard assembly of claim 1, wherein the first elongate portion comprises a flexible first length, wherein the second elongate portion comprises a flexible second length, and wherein the flexible second length is less than the flexible first length.

8. The lanyard assembly of claim 1, wherein the electrical conductor is a first electrical conductor, and wherein the lanyard assembly further comprises:
a second I/O device; and
a second electrical conductor, wherein the second electrical conductor extends between the second I/O device and at least one of the electrical connector and the first electrical conductor.

9. The lanyard assembly of claim 8, comprising a node, wherein the first and second electrical conductors extend through the node, wherein the first electrical conductor extends through the node in a first direction, wherein the second electrical conductor extends through the node in a second direction, and wherein the second direction is opposite to the first direction.

10. The lanyard assembly of claim 9, wherein at least one of the first and second electrical conductors is slidably held in the node.

11. The lanyard assembly of claim 8, comprising:
a first cord portion, comprising:
the first electrical conductor; and
a first outer sheath surrounding the first electrical conductor; and
a second cord portion, comprising:
the second electrical conductor; and
a second outer sheath surrounding the second electrical conductor, wherein the first and second cord portions form a loop for placement around a user's neck.

12. A device for holding a portable electronic such that the portable electronic hangs from the device, wherein the device comprises:
a cord configured to form a loop for placement around a person's neck, wherein the cord comprises:
an electrical conductor; and
a sheath around the electrical conductor; and
a multi-ended portion extending from the cord, comprising:
a first elongate portion, comprising:
a first end;
a second end; and
an electrical connector at the second end, wherein the electrical connector is configured to operably mate with the portable electronic, and wherein the first elongate portion is configured to carry one of more signals between the portable electronic and the first end; and
a second elongate portion, comprising:
a first end secured to the first end of the first elongate portion;
a second end; and
a physical connector at the second end, wherein the physical connector is configured to snap-fit around a portion of the portable electronic.

13. The device of claim 12, wherein the first and second elongate portions are flexible.

14. The device of claim 12, wherein the physical connector comprises a clip that comprises an aperture, wherein the portion of the portable electronic comprises a retractable button, and wherein the aperture of the clip is configured to receive the button to physically connect the second elongate portion to the portable electronic.

15. The device of claim 12, further comprising a pair of earphones.

16. A device, comprising:
a multi-ended device holder, comprising:
a first flexible portion comprising an electrical connector at a distal end thereof, wherein the electrical connector is configured to operatively mate with a portable electronic device; and
a second flexible portion comprising a clip at a distal end thereof, wherein the clip comprises an aperture configured to receive a portion of the portable electronic device; and
a cord extending from the multi-ended device holder, wherein the cord is configured to form a loop for placement around a user's neck, and wherein the cord is configured to carry one or more signals between the multi-ended device holder and a peripheral I/O device operatively coupled to the cord.

17. The device of claim 16, wherein the portable electronic device comprises a protrusion, and wherein the aperture of the clip is configured to snap-fit around the protrusion to physically connect the second flexible portion to the portable electronic device.

18. The device of claim 16, wherein the electrical connector comprises an audio jack.

19. The device of claim 16, wherein the cord comprises a pair of cord pieces, wherein the peripheral I/O device comprises a pair of personal speakers, and wherein each cord piece of the pair of cord pieces carries one of more signals to a personal speaker of the pair of personal speakers.

20. The device of claim 19, comprising a slide adjuster, wherein the pair of cord pieces each slidably extends through the slide adjuster, and wherein the cord pieces extend through the slide adjuster in opposite directions.
